(19) United States
(12) Patent Application Publication
(10) Pub. No.: US 2011/0129750 A1
(43) Pub. Date: Jun. 2, 2011

(54) DIRECT METHANOL FUEL CELL AND ELECTRONIC DEVICE

(76) Inventors: Tomohiro Hirayama, Ome-shi (JP); Katsuya Oto, Asaka-shi (JP)

(21) Appl. No.: 12/941,810

(22) Filed: Nov. 8, 2010

(30) Foreign Application Priority Data
Nov. 30, 2009 (JP) JP 2009-272635

(51) Int. Cl. H01M 8/04

(52) U.S. Cl. 429/432

(57) ABSTRACT

According to one embodiment, a fuel cell, includes a stack includes blocks, each of the blocks includes direct methanol type cells, a connection module configured to switch between connection and disconnection between a block of the blocks and a load, according to an instruction, a voltage value detector configured to detect an output voltage value of the block, a determination module configured to determine whether an output restoration process is performed on the block based on an output voltage value of the block, and a controller configured to transmit, to the connection module, an instruction for connecting the load to the block when first determination module determines that the output restoration process is performed on the block, and to transmit, to the connection module, an instruction for disconnecting the load from the block when the output voltage value has become less than or equal to a set voltage value.

### CROSS-REFERENCE TO RELATED APPLICATIONS

This application is based upon and claims the benefit of priority from Japanese Patent Application No. 2009-272635, filed Nov. 30, 2009; the entire contents of which are incorporated herein by reference.

### FIELD

Embodiments described herein relate generally to a direct methanol fuel cell, an electronic device, and an information processing device for restoring an output voltage.

### BACKGROUND

In direct methanol fuel batteries, cells, which form the minimum unit for electric power generation, are electrically arranged in series, and form a stack. An aqueous solution of methanol and air are used as a fuel. The fuel cell is configured such that the fuel is distributed to the cells arranged in series. The cells generate electric power using the supplied fuel. By cooling the cells heated by the general electric power using a fan, the methanol fuel cell is controlled to an optimum temperature. The electric power is usually supplied by connecting power collecting plates arranged on both sides of a cell forming a stack to a load.

In a fuel cell that generates electric power according to the above-described mechanism, it is known that, a platinum (Pt) surface, which performs chemical reaction on the cathode side, is more covered with an oxide due to the air being used as the fuel as the power generation time increases on the cathode side of the cell, which uses air as a fuel. This results in deterioration in speed of chemical reaction on the cathode side and deterioration in overall output of the stack.

Accordingly, it is considered effective to stop supplying fuel and generating electric power and then start supplying fuel and generating electric power. Since this approach emits an extremely large amount of methanol gas at the time of resumption of power generation, as well as stops generating electric power of the fuel cell, this approach cannot be adopted from the viewpoint of safety.

An approach of restoring the output voltage of the stack is disclosed in Jpn. Pat. KOKAI Application No. 2008-243608. According to this approach, the load on the cell is temporarily raised and returned to the original load. Using this method, the potential of the cathode can be risen to a desired potential, and the Pt surface on the cathode side can be returned to the original clean surface.

In the above-described conventional technique, a high load is applied to the overall stack, and it has been confirmed that methanol gas is emitted by an amount that exceeds the concentration (33 ppm) that is the threshold of the human sense of smell.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram illustrating a configuration of an electronic device according to the embodiment.

FIG. 2 is an exemplary perspective view illustrating a configuration of a stack of a direct methanol fuel cell according to the embodiment.

FIG. 3 illustrates an exemplary configuration of a cell according to the embodiment.

FIG. 4 is an exemplary block diagram illustrating a configuration of a direct methanol fuel cell according to the embodiment.

FIG. 5 is an exemplary flowchart illustrating the procedure for processing in the direct methanol fuel cell according to the embodiment.

### DETAILED DESCRIPTION

Various embodiments will be described hereinafter with reference to the accompanying drawings.

In general, according to one embodiment, a direct methanol fuel cell using methanol as a fuel, includes a stack, a voltage value detector, a first determination module, and a connection module. The stack comprises blocks and to which a first load is connected, each of the blocks comprising cells, each of the cells comprising a fuel electrode arranged on one side of an electrolyte film and an oxidant electrode arranged on the other side of the electrolyte film, the fuel electrode comprising an anode catalyst, receiving fuel, and emitting a gas generated by a chemical reaction promoted by the anode catalyst, the oxidant electrode comprising a cathode catalyst and to which air is supplied. The voltage value detector is configured to detect an output voltage value of each of the blocks. The first determination module configured to determine whether an output restoration process is performed on a block of the blocks based on a output voltage value of the block detected by the voltage value detector. The connection module configured to connect a second load greater than the first load to the block when the first determination module determines that the output restoration process is performed on the block, and to disconnect the block from the second load after output voltage value of the block has become a voltage value at which oxygen is deficient in the oxidant electrode of the block.

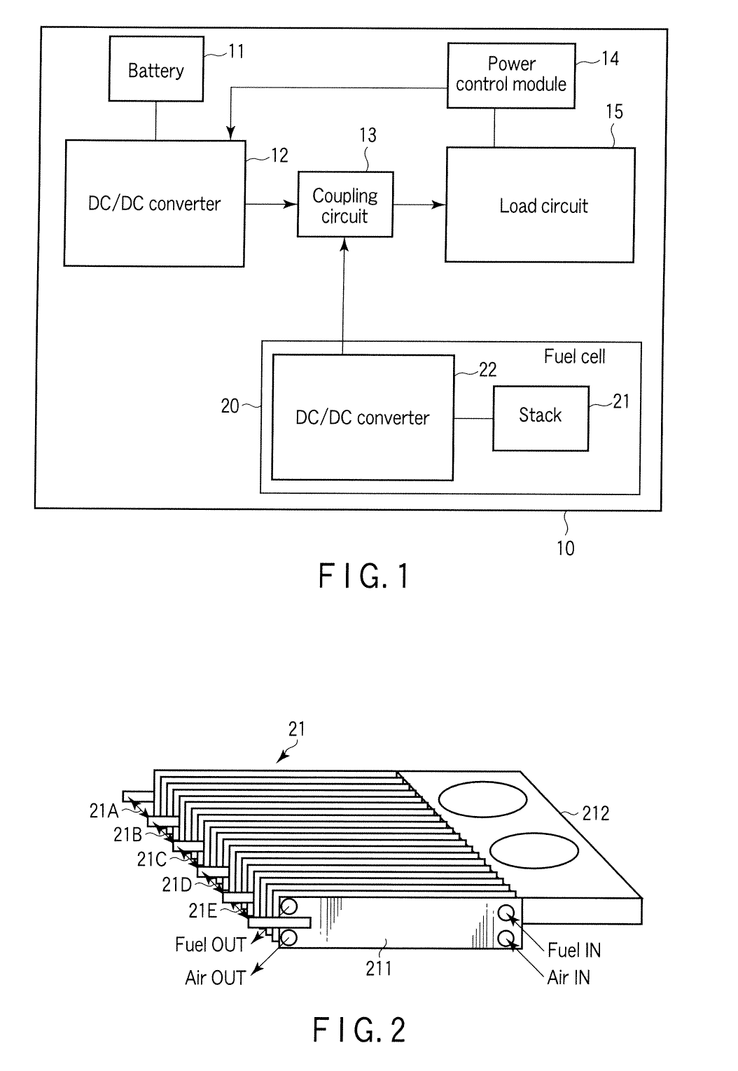

FIG. 1 is a block diagram illustrating a configuration of an electronic device according to an embodiment.

An electronic device 10 is a portable device, such as a personal computer, a FDA, and an AV player, and is configured so as to be driven by an integrated battery and a fuel cell. A battery 11 formed of a secondary battery is used as the integrated battery. The fuel cell may be configured to be connected to the electronic device as an external device, instead of being integrated therein.

In the main body of the electronic device 10, a DC/DC converter circuit 12, a coupling circuit 13, a power control module 14, and a load circuit (first load) 15, as well as the battery 11, are provided. The DC/DC converter circuit 12 is a switching power circuit configured to generate electric power to be supplied to the load circuit 15 from the battery 11, and is formed of a step-down switching regulator, for example. In the main body of the electronic device 10, the coupling circuit 13, configured to couple outputs of the DC/DC converter circuit 12 and the fuel cell 20 and supply the combined power to the load circuit 15, is provided.

The DC/DC converter circuit 12 includes a discharge mode, in which electric power is supplied to the load circuit 15, and a charge mode, in which the battery 11 is charged using the power of the fuel cell 20. In the discharge mode, the switching element is switching-controlled using a fixed frequency pulse width modulation signal (PWM signal), which varies in duty ratio.

The load circuit 15 is a CPU or an I/O device, for example, and varies in power consumption according to the processing situation.

The power control module 14 monitors the operation state of the load circuit 15. The power control module 14 sets the discharge mode in the DC/DC converter circuit 12 when the power consumption of the load circuit 15 is greater than or equal to the output power of the fuel cell 20. Further, the power control module 14 sets the charge mode in the DC/DC converter circuit 12 when the power consumption of the load circuit 15 is less than the output power of the fuel cell 20 and the electric power is excessive.

The fuel cell 20 includes a fuel cell stack 21, a DC/DC converter circuit 22, and the like. The DC/DC converter circuit 22 controls the current value of the input current or the output current value of the fuel cell stack 22 to a constant value.

FIG. 2 is a perspective view illustrating a configuration of a stack of a direct methanol fuel cell according to the embodiment.

Cells 211, which form the minimum unit for electric power generation, are electrically arranged in series and form a stack 21. Methanol water and air are used as fuel. The stack 21 is configured to distribute the fuel to the cells 211 arranged in series. The cells 211 generate electric power using the supplied fuel. By cooling the cells 211 heated by the generated electric power using a fan 212, the cells are controlled to an optimum temperature. The electric power is usually supplied by connecting power collecting plates arranged on both sides of the cells forming the stack to the load.

The stack 21 is formed by connecting in series blocks 21A, 21B, 21C, 21D, and 21E, each including a certain number of cells 211.

Blocks 21A, 21B, 21C, 21D, and 21E are arbitrarily designed according to the properties of the cells, under the following constraints:

1. The block including a plurality of cells means a collective cell including cells by the number greater than or equal to two and less than (the number of all the cells forming the stack)—(2).

2. Not all the blocks necessarily need to be formed of the same number of cells, and an arbitrary number of cells may form the blocks under the constraint shown in 1.

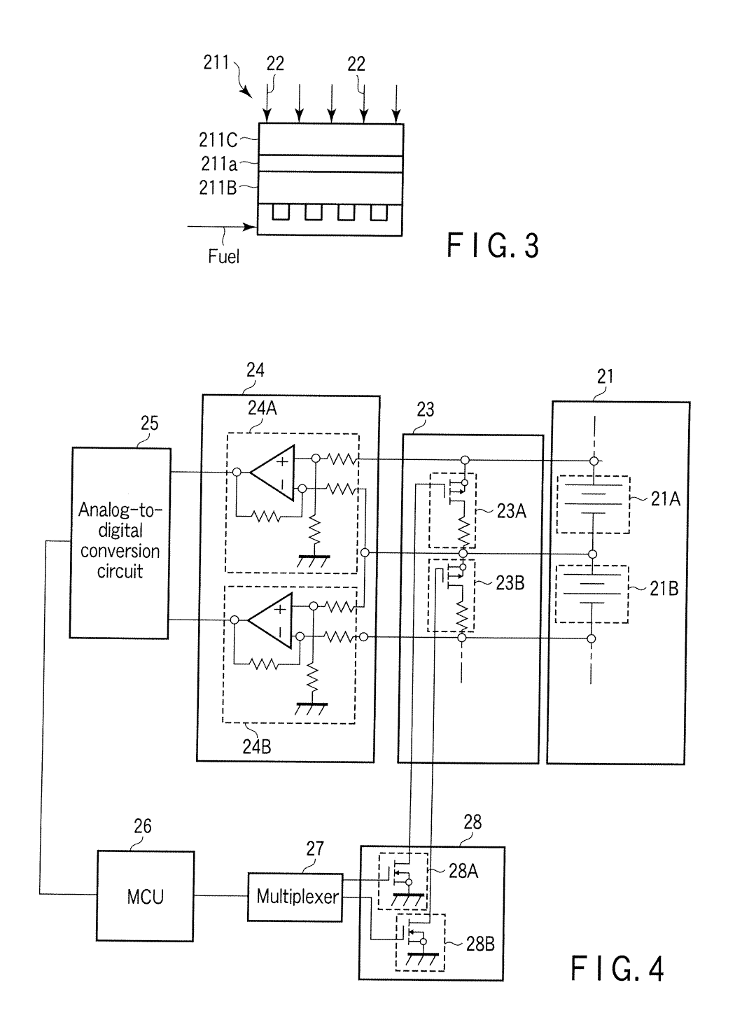

Next, the configuration of the cell will be described with reference to FIG. 3.

The cell 211 includes an electrolyte film 211A, a fuel electrode 211B, which includes an anode catalyst and is arranged on one side of the electrolyte film 211A, to which a liquid fuel is supplied, and from which a gas generated by a chemical reaction promoted by the anode catalyst is emitted, and an oxidant agent electrode 211C, which includes a cathode catalyst and arranged on the other side of the electrolyte film, and to which air is supplied. The cell 211 generates electric power using an aqueous solution of methanol obtained by diluting methanol (CH₃OH) with water (H₂O) to several to several tens %, for example. The electrolyte film 211A is formed of a polymeric film having a proton conductivity, for example, the fuel electrode 211B primarily includes platinum (Pt) and ruthenium (Ru), for example, as catalysts, and the oxidant electrode 211C primarily includes platinum (Pt), for example, as a catalyst.

The oxidant electrode 211C includes an air supply channel and a drain channel, not shown, which communicate with air, and air 22 is naturally supplied to the oxidant electrode 211C via the air supply channel by distribution, convection, and the like.

The liquid fuel supplied to the fuel electrode 211B discharges carbon dioxide (CO)hydrogen ions (H⁺), and electrons (e⁻) after reacting by means of the catalyst (mainly platinum (Pt) and ruthenium (Ru), for example) included in the fuel electrode 211B, as follows.

CH₃OH+H₂O→CO₂+6H⁺+6e⁻

The hydrogen ions (H⁺) pass through the electrolyte film 211A from the side of the fuel electrode 211B to the side of the oxidant electrode 211C, and reacts with oxygen (O₂) supplied to the oxidant electrode 211C, via the air supply channel by means of the catalyst (platinum (Pt), for example) included in the oxidant electrode 211C, as follows:

3/2O₂+6H⁺+6e^{-→}3H₂O

When electrons (e⁻) flow to the outside from the anode, a predetermined amount of electric power is generated.

The water generated in the oxidant electrode 211C is emitted outside the cell 211 via a drain channel, not shown, and is kept as it is or returned to a liquid fuel tank where liquid fuel is stored.

The carbon dioxide (CO₂) generated in the fuel electrode 211B is emitted outside the cell 211 together with the liquid fuel unreacted in the fuel electrode 211B.

The fuel cell has a problem that it deteriorates in output with elapse of operation time. Among various reasons that are considered to cause this problem, the reason that reliably occurs in a relatively short time is oxidation of a catalyst in the oxidant electrode 211C. This period differs according to the type and properties of the fuel cell.

In the fuel cell of the present embodiment, when the electric power generated by blocks 21A, 21B, 21C, . . . in the stack 21 becomes lower than a predetermined reference value, or at predetermined time intervals, the load of the fuel cell is increased. More specifically, the load is increased by supplying electric power generated from blocks 21A, 21B, 21C, . . . to the discharge module 23. By connecting the resistance of the discharge module 23, the load current is increased, the striking voltage generated by the block 12 is made lower than a predetermined voltage, and thereby the load is increased.

FIG. 4 is a block diagram illustrating a configuration of a direct methanol fuel cell according to the embodiment.

As shown in FIG. 4, the direct methanol fuel cell comprises a stack 21, a discharge module 23, a voltage detection module 24, an analog-to-digital conversion circuit 25, a micro-controller unit (MCU) 26, a multiplexer 27, a discharge switch module 28, and the like.

The stack 21 includes a plurality of blocks 21A, 21B, . . . . Each of blocks 21A, 21B, . . . includes a plurality of cells 211. The number of cells 211 forming blocks 21A, 21B, . . . may differ from block to block.

The discharge module 23 includes a plurality of discharge circuits 23A, 23B, . . . . Each of discharge circuits 23A, 23B, . . . includes a resistance (second load) higher than the load of the load circuit 15 connected in series, and a switch. The resistance and the switch are connected in parallel to the block. Each of discharge circuits 23A, 23B, . . . applies a load to corresponding blocks 21A, 21B, . . . and rapidly reduces the output voltage value of blocks 21A, 21B, . . . .

The voltage detection module 24 includes a plurality of voltage detection circuits 24A, 24B, . . . . Each of voltage detection circuits 24A, 24B, . . . detects the output voltage value of corresponding blocks 21A, 21B, . . . . Each of voltage detection circuits 24A, 24B, . . . outputs the detected voltage value as an analogue signal.

The analog-to-digital conversion circuit 25 converts the voltage value detected by voltage detection circuits 24A, 24B into digital signals. The analog-to-digital conversion circuit 25 outputs the converted digital signal into MCU 26.

The MCU 26 monitors the output voltage value of each of blocks 21A, 21B. The MCU 26 determines whether to perform an output restoration process for restoring the deteriorated output voltage, which will be described later, based on each of the output voltage values. Further, the MCU 26 determines whether the operation time of the stack 21 has elapsed a predetermined period of time. The MCU 26 transmits a connection instruction for instructing the multiplexer 27 to turn on the discharge switch of a corresponding block to the discharge switch module 28, when deterioration in output voltage value of the block has been recognized, or when the operation time of the stack 21 has exceeded a set operation. The multiplexer 27 performs an output restoration process by performing an operation of turning on only the instructed discharge switch from among discharge switches 28A, 28B, . . . of the discharge switch module 28.

The cells and the block voltage are always monitored by the MCU 26 even when the discharge switch is in an OFF state. The MCU 26 performs control such that the discharge switch maintains the ON state until the output voltage of the block becomes less than or equal to the voltage value at which oxygen becomes deficient in the oxidant electrode in the block, such as greater than or equal to 0 V and less than or equal to 0.1 V. When this state has been reached, the MCU 26 transmits a release instruction to the discharge switch module 28 for turning off the discharge switch, and thereby the normal load state is restored and the output restoration process is finished. The output restoration process may be ended after maintaining the state in which the output voltage of the block becomes greater than or equal to 0 V and less than or equal to 0.1 V for a predetermined period of time.

It is important to perform the output restoration process block by block, since the amount of emission of methanol gas would increase if the output restoration process was performed in a plurality of blocks simultaneously. The procedure for performing the output storage process in a plurality of blocks varies according to the properties of the cell and may be arbitrarily set. When there is no particular specification, the procedure is performed block by block in the order from an end (either anode or cathode) of the stack.

The appropriate timing for executing the output restoration process should basically be performed periodically by using the electric power generation time of the overall stack as a trigger. In the present circumstances, the time should preferably be approximately 1 hour, but may be varied as appropriate according to the properties of the cell.

Further, the voltage decreasing rate is calculated per unit time, based on the current voltage mean value V (=Overall voltage of the blocks/the number of cells forming the block), the maximum value Vmax of the voltage mean value of the same block immediately after execution of the nearest periodic output restoration process, and the power generation time H (hour) after execution of the periodic output restoration process. The voltage decreasing rate per unit time is calculated by {(V−Vmax)/Vmax/H}×100 [%/hour]. By performing the output restoration process before the calculated voltage decreasing rate becomes a voltage decreasing rate indicating the state in which the voltage value of the electric power output by the output restoration process cannot be increased, it is possible to cope with the case where an oxide in the air enters the cathode.

For example, when the calculated voltage decreasing rate is less than or equal to a preset voltage decreasing rate (such as −5%/hour operation), the output restoration process is performed promptly on the block without waiting for the periodic output restoration process execution timing. It is thereby possible to cope with the case where an oxide in the air enters the cathode. The value −5%/hour is determined by natural deterioration (oxidation) of the current catalyst of the direct methanol type fuel cell, and is within a numerical range in which the output voltage can be restored.

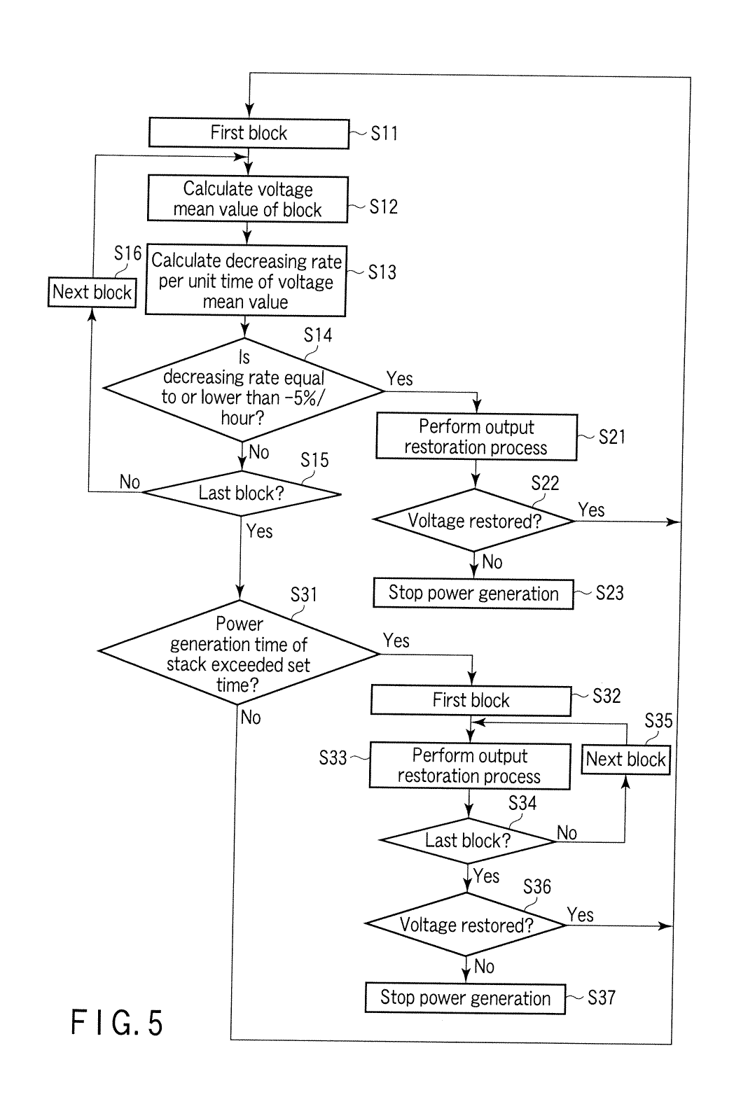

Next, the procedure for the output restoration process will be described with reference to the flowchart of FIG. 5.

First, the first block is selected (block S11). The first block is a block at an end (either anode or cathode) of the stack, for example. The voltage mean value V (=entire voltage of the blocks/the number of blocks) of the selected block is calculated (block S12). The decreasing rate per unit time of the voltage mean value of the selected block is calculated based on the voltage mean value V of the blocks, the maximum value Vmax of the voltage mean value of the same block immediately after execution of the latest periodic output restoration process, and the power generation time H (hour) after the execution of the periodic output restoration process (block S13). After that, it is determined whether the calculated decreasing rate is less than or equal to −5%/hour (block S14). When the decreasing rate has not been determined as being less than or equal to −5% (NO in block S14), it is determined whether the block on which determination as to the decreasing rate has been performed in block S14 is the last block or not (block S15). The last block means a block at an end opposite to the block selected in block S11. When it has been determined that the block is not the last block (NO in block S15), the next block is selected (block S16). The next block is a block that is adjacent to the block on which determination as to the decreasing rate has been performed in block S14 and has not yet been selected. After the selection, the procedure of the blocks S12-S15 is sequentially performed.

When the decreasing rate has been determined in block S14 as being less than or equal to −5%/hour (Yes in block S14), the output restoration process is performed on the block that has been determined as having a decreasing rate less than or equal to −5%/hour (block S21). After execution of the output restoration process, it is determined whether the voltage of the block has been restored (block S22). When it has been determined that the voltage has not yet been restored (NO in block S22), the power generation of the stack is stopped (block S23). When it has been determined that the voltage has been restored (Yes in block S22), the process of block S11 is sequentially performed.

When the block is determined as being the last block in block S15 (Yes in block S15), it is determined whether the power generation time of the stack has exceeded a set time (1 hour, for example) (block S31). When the power generation time of the stack has been determined as not exceeding the set time (No in block S31), the operation is sequentially performed from the block S11.

When the power generation time of the stack has been determined as exceeding the set time (Yes in block S31), the first block is selected (block S32). The first block means the block at an end (either anode or cathode) of a stack, for example. The output restoration process is performed on the selected block (block S33).

In block 333, it is determined whether the block subjected to the output restoration process is the last block or not (block S34). The last block means a block at an end opposite to the block selected in block S32. When the block has been determined as not being the last block (No in block S34), the next block is selected (block S35). The next block is a block that is adjacent to the block on which the decreasing rate has been determined in block S14 and has not yet been selected. After the selection, the procedure of the blocks 333, S34 is sequentially performed. When the block has been determined as being the last block (Yes in block S34), it is determined whether the output voltage of each of the blocks has been restored or not (block S36). When it has been determined that the output voltage has been restored (Yes in block S36), the procedure of block S11 is sequentially performed. When it has been determined that a block exists in which the output voltage is not restored (No in block S36), the power generation process of the stack is stopped.

As a result of the above-described processes, the output voltage can be restored by performing a voltage restoration process when the output voltage of the block has deteriorated. Since the voltage restoration process is performed on one block when the output voltage of the block has deteriorated, the amount of emission of methanol gas can be made lower than the concentration (33 ppm) that is the threshold value of the human sense of smell. Further, when the operation time of the stack has exceeded a set time, by performing the voltage restoration process block by block, deterioration in the output voltage of the block can be suppressed, and the amount of emission of methanol gas can be made lower than the concentration (33 ppm) which is the threshold value of the human sense of smell. Further, since the voltage restoration process is performed block by block, the power generation of the fuel cell never stops while the fuel cell is being used.

Moreover, since the voltage restoration process is performed per block unit, instead of performing the voltage restoration process simultaneously over a plurality of blocks, the amount of heat generated at the time of voltage restoration process can be suppressed. Thereby, a fan having low cooling properties can be used, compared to the case where the voltage restoration process is performed on the overall stack.

It is to be noted that cells of a block at an end should preferably be designed to have a small number of cells, compared to other blocks, as cells of a block at an end of a stack are easily oxidized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A direct methanol fuel cell comprising:
a stack comprising blocks and to which a first load is connected, each of the blocks comprising cells, each of the cells comprising a fuel electrode arranged on one side of an electrolyte film and an oxidant electrode arranged on the other side of the electrolyte film, the fuel electrode comprising an anode catalyst, receiving fuel, and emitting a gas generated by a chemical reaction promoted by the anode catalyst, the oxidant electrode comprising a cathode catalyst and to which air is supplied;
a voltage value detector configured to detect an output voltage value of each of the blocks; and
a first determination module configured to determine whether an output restoration process is performed on a block of the blocks based on an output voltage value of the block detected by the voltage value detector; and
a connection module configured to connect a second load greater than the first load to the block when the first determination module determines that the output restoration process is performed on the block, and to disconnect the second load from the block after the output voltage value of the block has become a voltage value at which oxygen is deficient in the oxidant electrode of the block.

2. The direct methanol fuel cell of claim 1, wherein
the first determination module is configured to determine that the output restoration process is performed on the block when a first voltage mean value of the block is less than or equal to a first threshold value, a second voltage mean value of the block is less than or equal to a second threshold value, or a voltage decreasing rate per unit time of the block is less than or equal to a third threshold voltage,
the first voltage mean value is calculated by dividing a first output voltage value of the block after the output restoration process is performed last time on the block by the number of cells in the block, the second voltage mean value is calculated by dividing a second output voltage value of the block after the measurement of the first output voltage value by the number of cells in the block, and the voltage decreasing rate per unit time is calculated based on a period of time until the second output voltage value is measured since the first output voltage value is measured,
the first, second, and third threshold voltages are set within a range in which a voltage value of an electric power output from the block can be increased by the output restoration process.

3. The direct methanol fuel cell of claim 1, further comprising a second determination module configured to determine whether the output restoration process is performed on the blocks based on an operation time after the output restoration process is performed last time on the stack, wherein
the connection module is configured to connect the second load to one block of the blocks when the second determination module determines that the output restoration process is performed on the blocks and to disconnect the second load from the one block after output voltage value of the one block has become a voltage value at which oxygen is deficient in the oxidant electrode of the one block for each of the blocks sequentially.

4. The direct methanol fuel cell of claim 1, wherein the number of cells included in a block at an end portion of the stack is less than the number of cells included in a block at a portion other than the end portion of the stack.

5. A direct methanol fuel cell comprising:
a stack including comprising blocks, each of the blocks comprising direct methanol type cells;
a connection module configured to switch between connection and disconnection between one block of the blocks and a load, according to an instruction;
a voltage value detector configured to detect an output voltage value of each of the blocks;
a first determination module configured to determine whether an output restoration process is performed on a block of the blocks based on an output voltage value of the block detected by the voltage value detector; and
a control module configured to transmit, to the connection module, an instruction for connecting the load to the block when the first determination module determines that the output restoration process is performed on the block, and to transmit, to the connection module, an instruction for disconnecting the load from the block when an output voltage value of the block has become less than or equal to a set voltage value of greater than or equal to 0 V.

6. An electronic device comprising:
a direct methanol fuel cell, comprising:
a stack comprising blocks and to which a first load is connected, each of the blocks comprising cells, each of the cells comprising a fuel electrode arranged on one side of an electrolyte film and an oxidant electrode arranged on the other side of the electrolyte film, the fuel electrode comprising an anode catalyst, receiving supplied fuel, and emitting a gas generated by a chemical reaction promoted by the anode catalyst, the oxidant electrode comprising a cathode catalyst and to which air is supplied;
a voltage value detector configured to detect an output voltage value of each of the blocks;
a first determination module configured to determine whether an output restoration process is performed on a block of the blocks based on an output voltage value of the block detected by the voltage value detector; and
a connection module configured to connect a second load greater than the first load to the block when the first determination module determines that the output restoration process is performed on the block, and to disconnect the second load from the block after output voltage value of the block has become a voltage value at which oxygen is deficient in the oxidant electrode of the block.

7. The electronic device of claim 6, wherein
the first determination module is configured to determine that the output restoration process is performed on the block when a first voltage mean value of the block is less than or equal to a first threshold value, a second voltage mean value of the block is less than or equal to a second threshold value, or a voltage decreasing rate per unit time of the block is less than or equal to a third threshold voltage,
the first voltage mean value is calculated by dividing a first output voltage value of the block after the output restoration process is performed last time on the block by the number of cells in the block, the second voltage mean value is calculated by dividing a second output voltage value of the block after the measurement of the first output voltage value by the number of cells in the block, and the voltage decreasing rate per unit time is calculated based on a period of time until the second output voltage value is measured since the first output voltage value is measured,
the first, second, and third threshold voltages are set within a range in which a voltage value of an electric power output from the block can be increased by the output restoration process.

8. The electronic device of claim 6, wherein the direct methanol fuel cell further comprises a second determination module configured to determine whether the output restoration process is performed on the blocks based on an operation time after the output restoration process is performed last time on the stack, wherein
a connection module configured to connect a second load to one block of the blocks when the second determination module determines that the output restoration process is performed on the blocks, and to disconnect the second load from the one block after output voltage value of the one block has become a voltage value at which oxygen is deficient in the oxidant electrode of the one block for each of the blocks sequentially.

9. The electronic device of claim 6, wherein the number of cells included in an end portion of the stack is less than the number of cells included in a block at a portion other than the end portion of the stack.
